(19) United States
(12) Patent Application Publication
(10) Pub. No.: US 2003/0197078 A1
(43) Pub. Date: Oct. 23, 2003

(54) Spraycoating device

(75) Inventors: Felix Mauchle, Abtwil (CH); Hanspeter Vieli, Goldach (CH)

Correspondence Address: LOWE, HAUPTMAN, GILMAN & BERNER, LLP (ITW), 1700 DIAGONAL ROAD, SUITE 300, ALEXANDRIA, VA, 22314, US

(73) Assignee: ITW GEMA AG

(21) Appl. No.: 10/396,467

(22) Filed: Mar. 26, 2003

(30) Foreign Application Priority Data
Apr. 19, 2002 (DE) 102 17 653.1

(51) Int. Cl. B05B 5/00

(52) U.S. Cl. 239/690.1

(57) ABSTRACT

A spraycoating device at least one hollow high-voltage electrode (10) fitted with a compressed-air path (22) issuing from said electrode's end used to electrostatically charge the coating material. Preferably the high-voltage electrode (10) is a thin tube made of or comprising an electrically conducting material.

The present invention relates to a spraycoating device defined in the preamble of claim 1.

A spraycoating device of this kind is disclosed in U.S. Pat. No. 4,993,645. Said patent shows a hand-held spraycoating device and a spraycoating device which is held in a support, both devices operating with coating powders. Moreover the European patent document 0,164,837 B1 discloses an electrostatic spraycoating device for liquid coating materials., They comprise high-voltage electrodes to electrostatically charge the coating material. In general the electrode is cannular or a kind of a filamentary wire situated in a compressed-air duct. The compressed air is used to prevent the coating material from adhering or sintering to the electrode. The electrode, its support and means required to constitute the compressed-air duct must be designed in such manner that they shall only minimally degrade the flow of coating material. At the same time, however, the electrostatic charging must be efficient.

Several high-voltage electrodes also may be used instead of a single one.

The objective of the present invention is improving in simple manner the efficiency and the quality of coating.

This objective is attained by the features of claim 1 of the present invention.

According to this invention, said problem is solved in that the compressed-air path runs through the electrode and issues from that end of the high-voltage electrode which is used to electrostatically charge the coating material.

Preferably the high-voltage electrode is a tube, preferably a thin, cannular tube made of or fitted with an electrically conducting material.

The present invention is based on the surprising observation made by the inventor that already minute changes in the radial position of the cannular or filamentary high-voltage electrode of the state of the art may entail unevenly electrostatically charging the sprayed flow of material and moreover alter its shape and its radial position. While attempts already have been and are being made to configure the high-voltage electrode radially centrally in the compressed-air duct, this goal is attained only rarely in practice. In any spraycoating device, even if of the same dimensions and tolerances, the high-voltage electrode will assume a position within the compressed-air duct or relative to a separately configured compressed-air duct which is off the theoretically optimal one. Frequently the high-voltage electrode is radially offset from the duct center and rests on one side against the wall of the duct. These deviations arise on account of kinks in the electrical hookup wire of the high-voltage electrode or in the said high-voltage electrode itself in the course of assembly and/or cleaning maintenance. As regards the state of the art, high-voltage electrode deviations from a design reference position were heretofore considered unsubstantial. If problems had been suspected, then presumably means would have been provided to more accurately position the electrode tip. The present and novel invention on the other hand follows a wholly new approach by proposing a high-voltage electrode which constitutes per se the compressed-air duct, or at least its downstream end.

Especially advantageously the high-voltage electrode is configured axially on the center line of the flow of coating material. However it may also be configured eccentrically to the said center line. Moreover the invention is applicable to any kind of spraycoating device, for instance those comprising a circular nozzle, a flat nozzle, irrotational or rotational nozzle cases to atomize the coating material. In especially advantageous manner, the invention also applies to devices spraying pneumatically transported, powdery coating materials. However the invention also applies to liquid coating materials.

The dependent claims define further features of the invention.

The invention is elucidated below by means of preferred illustrative embodiments and in relation to the attached drawings.

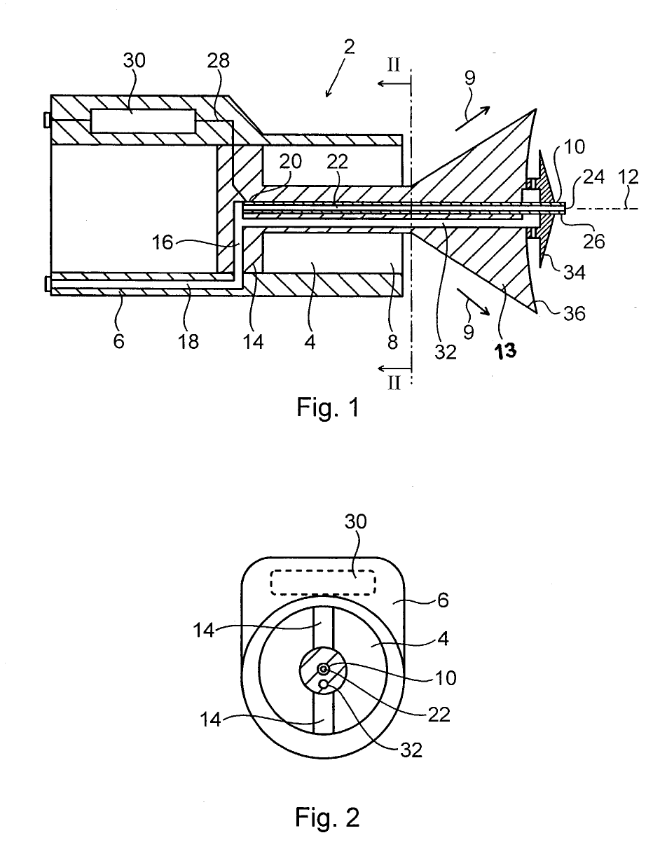

FIG. 1 schematically shows an axial section of a spraycoating device of the present invention,

FIG. 2 is a cross-section along plane II-II of FIG. 1,

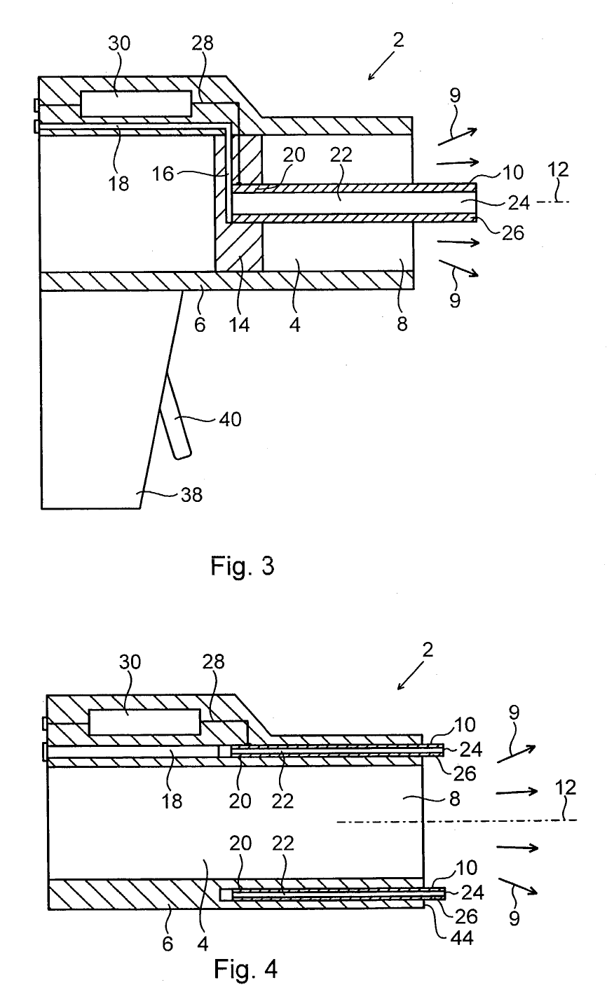

FIG. 3 is a longitudinal section of another embodiment of a spraycoating device of the present invention,

FIG. 4 is a longitudinal section of a still another embodiment of a spraycoating device of the present invention.

The spraycoating device 2 shown in FIG. 1 includes a coating-material duct 4 within a housing 6. The coating-material duct 4 is fitted with an output aperture 8 in the front end of the device from where issues the pneumatically moved, powdery coating material that flows in the form of a powder cloud 9 onto the object to be coated.

A thin tube (cannula) made of an electrically conducting material constitutes the high-voltage electrode 10 which is configured axially on the center line 12 of the flow of coating material. The tubular high-voltage electrode 10 runs axially through a baffle 13 which is configured downstream of the output aperture 8 and in the flow path of the coating material and which is affixed within the coating-material duct 4 by a bracket 14 to the housing 6. A compressed-air duct 16 runs through said bracket and communicates pneumatically on one hand with a compressed-air duct 18 in the housing 6 and on the other hand, at the rear end 20 of the tubular high-voltage electrode 10, with a connecting duct 22. As a result compressed air may flow through the connecting duct 22 of the high-voltage electrode 10 and then through its downstream compressed-air outlet 24 to prevent coating material from adhering or sintering to the downstream end 26 of the tubular high-voltage electrode 10. At the compressed-air outlet 24 and downstream from it, the flow of compressed air generates reduced pressure (venturi effect) to aspirate ambient air. This air flows over the outside of the high-voltage electrode 10 and keeps it free of coating material.

The rear end 20 of the high-voltage electrode 10 is connected by an electric cable 28 to a high-voltage generator 30. The high-voltage generator 30 preferably is situated inside the housing 6. In another embodiment of the present invention, the high-voltage generator 30 may also be mounted outside the housing 6.

FIG. 1 shows an embodiment wherein the compressed-air duct 16 of the bracket 14 also communicates pneumatically with a further compressed-air duct 32 running through the baffle 13 and issues at the front end of said baffle behind a central cap 34, whereby the compressed air from this compressed-air duct 32 is diverted by said cap 34 over the forward pointing end face 36 of the baffle 13 to run radially or obliquely downward and out into the atomized coating material. This feature precludes the coating material from depositing on this front end face 36 of the baffle 13.

FIG. 3 shows a spraycoating device of the invention that is designed similarly to the embodiment of FIGS. 1 and 2 but lacks a baffle 13. Components corresponding to those shown in FIG. 1 are denoted by the same references and already were described in relation to FIG. 1.

All embodiments may be spraycoating devices held automatically or manually. FIG. 3 shows in merely illustrative manner a grip 38 with a trigger 40.

As regards the further design of the spraycoating device of the invention shown in FIG. 4, at least one high-voltage electrode 10 is configured, not in the center line of the flow of coating material, but radially offset from it and projecting from a forward-pointing end face 44 of the housing 6. Only one high-voltage electrode 10 is used in many applications. FIG. 4 illustratively shows two such high-voltage electrodes. Again components corresponding to those of FIG. 1 are denoted by the same references and their description already was provided in relation to FIG. 1.

In all embodiments the high-voltage electrode 10 is a thin, cannular tube. Said electrode's downstream end 26 used for electrostatic charging may be dull or sharp. The compressed air flowing through the cannular or tubular high-voltage electrode 10 generates a venturi effect aspirating the neighboring compressed air issuing from the electrode and thereby rinsing the electrode tip. The position of the tubular high-voltage electrode 10 is defined and cannot be altered accidentally for instance during assembly or cleaning. As a result identical and reproducible effects of a given type of device will always be attained, even in mass production.

The high-voltage electrode 10 may be accurately positioned in predetermined manner in order to provide a desired effect on the sprayed flow of coating material. As a result electrode-position dependent effects are attained on the sprayed flow of coating material because the said electrode position is pre-determinable, instead of being susceptible to uncontrolled changes in position.

In all the above shown embodiments, the compressed-air outlet 24 consists of the downstream, end-face zone of the straight connecting duct 22. The compressed-air outlet 24 may consist of one or several discharge apertures of the high-voltage electrode 10. The outlet apertures may be configured axially or also transversely to the high-voltage electrode 10 and/or to the connecting duct 22. The high-voltage electrode 10 may be fitted with one or more connecting ducts 22 each comprising one or more of said outlet apertures constituting the compressed-air outlet 24. Preferably the high-voltage electrode 10 and/or its connecting duct 22, in particular latter's outlet aperture(s) constituting the compressed-air outlet 24, shall exhibit a circular cross-section. However said cross-sectional shape also may be oval, flat, angular or rounded and the like.

1. A spraycoating device to spraycoat objects, comprising at least one high-voltage electrode (10) to electrostatically charge coating material and one compressed-air path (22) to feed compressed air to the high-voltage electrode, characterized in that
the compressed-air path runs through at least one connecting duct (22) of the high-voltage electrode (10).

2. Spraycoating device as claimed in claim 1, characterized in that the high-voltage electrode (10) consists at least at its downstream end (26) of a cross-sectionally circular body.

3. Spraycoating device as claimed in claim 2, characterized in that the high-voltage electrode (10) is a thin tube made of or comprising an electrically conducting material.

4. Spraycoating device as claimed in at least one of the above claims, characterized in that the high-voltage electrode (10) is configured axially in a center line (12) of the flow path (4) of the coating material.

5. Spraycoating device as claimed in claim 4, characterized in that the connecting duct (22) issues axially relative to the flow path (4) of the coating material and in said path's center line (12).

6. Spraycoating device as claimed in at least one of claims 1 through 3, characterized in that the downstream of the high-voltage electrode (10) is radially offset from the line (12) of the flow path (4) of the coating material.

7. Spraycoating device as claimed in at least one of the above claims, characterized in that the connecting duct (22) is fitted with a compressed-air outlet (24) which is directed downstream relative to the coating-material direction of flow in the same direction or obliquely to this direction.

8. Spraycoating device as claimed in at least one of the above claims, characterized in that it exhibits a circular output aperture (8) to feed coating material.

9. Spraycoating device as claimed in at least one of the above claims, characterized in that it is designed to operate with pneumatically conveyed, powdery coating material.
